(19) United States
(12) Patent Application Publication
(10) Pub. No.: US 2015/0058042 A1
(43) Pub. Date: Feb. 26, 2015

(54) CONSOLIDATED PATIENT INFORMATION EXCHANGE

(71) Applicant: AET, LLC, Norfolk, NE (US)

(72) Inventor: Keith W. VRBICKY, Norfolk, NE (US)

(21) Appl. No.: 14/455,705

(22) Filed: Aug. 8, 2014

Related U.S. Application Data
(60) Provisional application No. 61/864,344, filed on Aug. 9, 2013.

(51) Int. Cl. G06F 19/00

(52) U.S. Cl. CPC G06F 19/321
USPC 705/3

(57) ABSTRACT

An integrated electronic healthcare exchange system includes a healthcare server and an interface coupled to the healthcare server. The healthcare server includes a processor coupled to a memory and a communications network. The healthcare server further includes a processing module for receiving from a call coordination center, via the communication network, healthcare data including DICOM formatted data and non-DICOM data received from an originating healthcare facility regarding a patient, and which permits a call coordinate to create a patient file, assign a unique claim ID to the patient file, and store the patient file in the memory of the healthcare server. The healthcare server further comprises a module which provides access to the stored patient file by the originating healthcare facility through the interface. The interface is coupled to the healthcare server and to the communication network.

### RELATED APPLICATIONS

This application claims priority to U.S. Provisional Application No. 61/864,344, filed Aug. 9, 2013 and titled “Consolidated Patient Information Exchange”, the entire disclosure of which is incorporated by reference.

### FIELD

The field relates to healthcare information communication and more particularly to a patient information exchange to facilitate collaboration and communication of patient information among healthcare providers.

### BACKGROUND

In the healthcare field, numerous care providers, such as hospitals, outpatient clinics, physician offices, create voluminous electronic records relating to a given patient's healthcare. One example of a present system for transfer of such records is shown in FIG. 1. In FIG. 1, an originating healthcare facility 20 (e.g. physicians hospitals, clinics, pharmacies, laboratories, etc.) may transfer certain records to a Call Coordinator 23 at a Call Coordinator Center 22, who relays the records to a Remote Healthcare Facility 24 (physicians, hospitals, clinics, pharmacies, laboratories, etc.). However, many electronic records are in a proprietary form or format, or comprise images, and are therefore not readily transferrable in this manner.

If a second healthcare provider on another site cannot obtain prompt and accurate records from an originating healthcare provider, the second healthcare provider may re-run tests, examinations, or treatments, thereby creating waste and driving up the cost of healthcare. Thus, there is a need for a system and process to improve the communication of records and information and improve consultations between healthcare providers.

### SUMMARY

An integrated electronic healthcare exchange system may include a healthcare server and an interface coupled to the healthcare server. The healthcare server may include a processor and a memory coupled to the processor, and the processor may be coupled to a communications network. The healthcare server may further include a processing module executed by the processor for receiving from a call coordination center, via the communication network, healthcare data including DICOM formatted data and non-DICOM data received from an originating healthcare facility regarding a patient, and which permits a call coordinate to create a patient file, assign a unique claim ID to the patient file, and store the patient file in the memory of the healthcare server. The healthcare server may further comprise a module which provides access to the stored patient file by the originating healthcare facility through the interface. The interface may be coupled to the healthcare server and to the communication network, and encapsulates the received healthcare data into a DICOM formatted packet and stores in the DICOM formatted packet in the patient file. In one example, communications between the healthcare server and the call coordinator may be initiated by a single-click of a computer input device. The integrated electronic healthcare exchange system may further include a video conferencing server coupled to the healthcare server to provide video communications between a distant site healthcare facility and the originating healthcare facility. In one embodiment, the call coordination center can display patient records and a video conference simultaneously.

In one example, the healthcare server is enhanced so that it may transfer, store and manipulate information in a variety of formats other than DICOM data. In another example, the remote healthcare facility communicates with the healthcare server via the interface which encapsulates non-DICOM data, sent from the distant site healthcare facility, into DICOM formatted packets.

A method for operating a consolidated healthcare data exchange may include the following steps. First, receiving, at a healthcare server including a server memory via a communication network, healthcare data regarding a patient transmitted from an originating healthcare facility and including non-DICOM formatted records. Second, the healthcare server creating a patient file for the patient using the received healthcare data and storing the patient file in the server memory in response to a request for a call coordination center. Third, an interface encapsulating the non-DICOM formatted records of the received healthcare records into DICOM formatted packets and storing the encapsulated DICOM formatted packets in the patient file. Fourth, the healthcare server providing access to the stored patient file by a distant site healthcare facility.

### BRIEF DESCRIPTION OF THE DRAWINGS

FIG. 1 is a block diagram of an example prior art system;

FIG. 2 is a block diagram of an example of a consolidated electronic patient healthcare information exchange, according to an example embodiment;

FIG. 3 is a block diagram of an example consolidated electronic patient healthcare information exchange configured to provide a video conferencing facilities according to an example embodiment;

FIG. 4 is a block diagram of an consolidated electronic patient healthcare information exchange example illustrating security components and workflow according to an example embodiment;

FIG. 5 is a layer diagram illustrating an enterprise imaging structure for a consolidated electronic patient healthcare information exchange according to an example embodiment;

FIGS. 6 and 7 comprise a block diagram of an example computer environment in which an example of the present invention may be implemented in different states of authentication of a user.

FIG. 8 is a block diagram of an example computer system within which a set of instructions for causing the machine to perform any one or more of the methodologies discussed herein may be executed or stored.

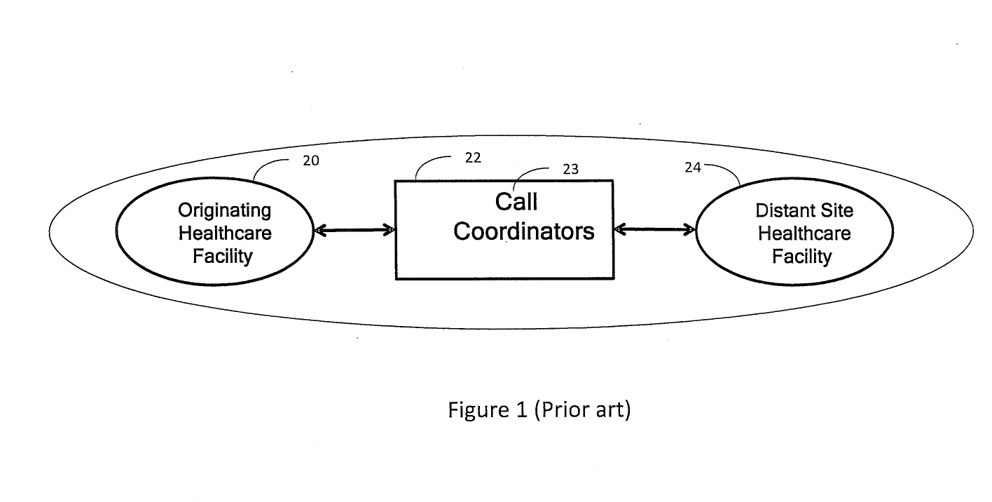

### DETAILED DESCRIPTION

Example methods and systems for integrated patient information exchange are described herein. In the following description, for purposes of explanation, numerous specific details are set forth in order to provide a thorough understanding of example embodiments. It will be evident, however, to one of ordinary skill in the art that embodiments of the invention may be practiced without these specific details.

The Consolidated Patient Information Exchanges (CPI) disclosed herein may also be generally described as Integrated Electronic Healthcare Exchanges. The disclosed Exchanges join Picture Archiving and Communication Systems (PACS) and videoconferencing technology over a secure network. These Exchanges deliver single log-in capability using a single user interface, expanded patient data capabilities to store, share and manage both PACS and non-PACS files (e.g. audio, video, text, etc.) in a secure and compliant environment that is tailored to the specific needs of a variety of healthcare specialists and practices, and new workflow processes specific to each healthcare environment to ensure that the Exchange workflow effectively fits into the healthcare environment and meets the needs and requirements of healthcare professionals and healthcare organizations. The CPI Exchange disclosed herein a telemedicine platform which combines videoconferencing with data exchange to allow a process of virtual care collaboration at the point of care. The process of data exchange is vendor neutral to Electronic Health Record (EHR) systems and radiologic imaging manufacturers.

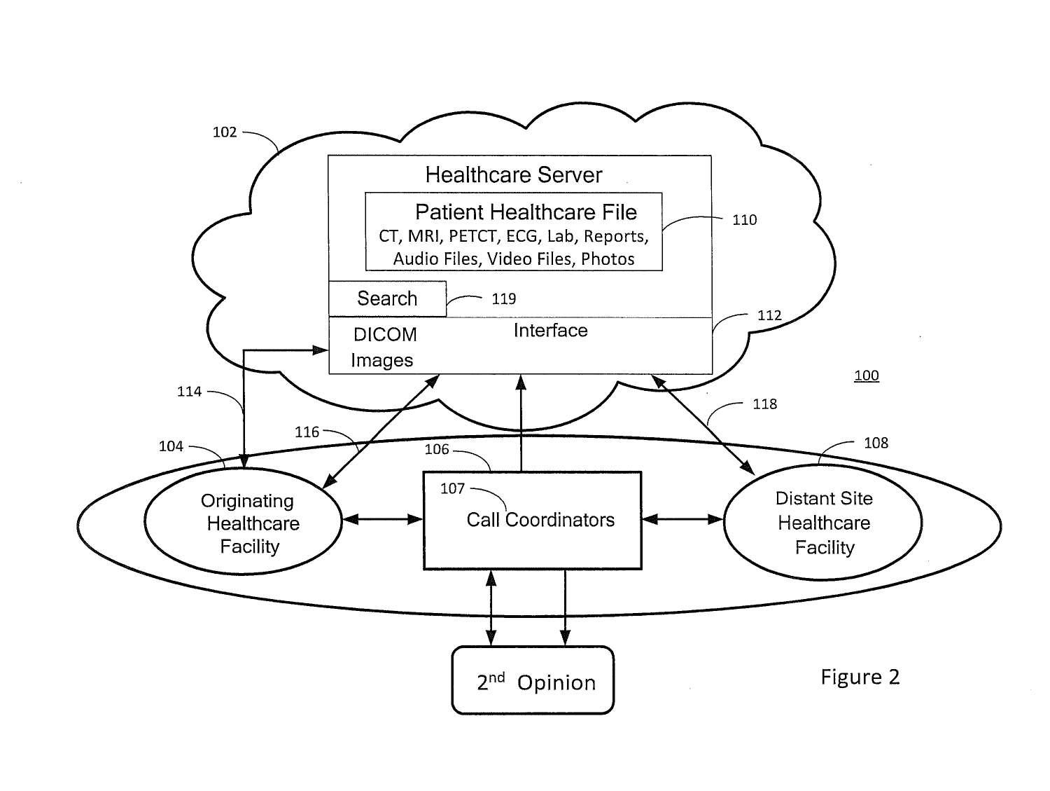

FIG. 2 is a block diagram of an example of an Consolidated Patient Information Exchange 100 illustrating data flow using a Healthcare Server 102, according to an example embodiment. In this example, an Originating Healthcare Facility 104 at an originating site communicates electronically with a Call Coordinator 107 at a Call Coordination Center 106. The Call Coordination 106 Center is coupled for electronic communication with a Distant Site Healthcare Facility 108. The Healthcare Server 102 is coupled in electronic communication with the Healthcare Facility 104, Call Coordination Center 106 and Distant Site Healthcare Facility 108, as shown. The Healthcare Server 102 includes a module which is configured to allow the Call Coordinator 107 to structure the Healthcare Server 102 and to create a Patient File 110 and assign a unique patent ID to the file for each patient. The Call Coordinator 107 receives healthcare records and images from the Healthcare Facility 104 and uploads the patient records to the Patient File 110. The medical records may comprise many different data types, for example, ECG results, laboratory test results, reports of examinations, photos, DICOM Images, X-Rays, other images, video, etc. The images may be, for example, in a format known as “DICOM” (Digital Image and Communication in Medicine) which is a standard that has been widely adapted by hospitals and other healthcare providers for handling, storing and transmitting medical images. The Healthcare Server 102 is configured to store the healthcare records, and includes an Interface 112 to perform encapsulation of records that are not in DICOM format (i.e. non-DICOM records), and to provide the other healthcare providers (e.g. Distant Site Healthcare Facility 108 and the Originating Healthcare facility) with access to the stored medical records. The Patient's File 110 may be made universally accessible to the originating site and other healthcare provider sites. Access may be secured by any of a variety of security procedures including by user name and/or password.

The Originating Healthcare Facility 104 may be equipped with various types of medical imaging equipment. In one example, the medical imaging equipment is configured using standard protocols (e.g. DICOM) that facilitate loading of medical images directly to the Healthcare Server 102. The transfer images may be transferred, for example, using a Picture Archiving and Communication System (PACS) which is a standard for storage and access to medical images which uses the DICOM image format. The medical images may comprise, for example, x-ray images, CT Scans, and other images. The images may be still images and/or motion images (e.g., video).

In the embodiments of FIG. 2, the PACS is enhanced to transfer, store, manipulate, and display healthcare records in non-DICOM formats, including, but not limited to , sound files (e.g., WAV files, mp3 files), video files (e.g., WMV files, MP4 files), text files (e.g., MS Word files, PDF files), and other formats. These records are transported and encrypted in compliance with HIPAA requirements. The CPI Exchange System 100 also allows for workflow to be structured specific to the individual healthcare providers current workflow. The workflow process can be order initiated to a final report.

An Interface Module 112 is provided within the Healthcare Server 102 which allows access to the Patient File 110. The Interface 112 permits the Originating Healthcare Facilities 104 to communicate with the Healthcare Server 102 by a direct DICOM Path 114 for transfer of DICOM images both to and from the patient file, and by a non-DICOM path through a private web page Link 116. This non-DICOM path permits communication with the Healthcare Server 102 by any of the many available data formats. Similarly, the Distant Site Healthcare Facility 108 may communicate in both directions with the Healthcare Server 102 via a non-DICOM Link 118. The non-DICOM Links 116, 118 may be, for example, through the internet, or other computer network, via a private webpage.

To gain access to the Healthcare Server 102 the Call Coordinator 107 may, for example, provide a link via e-mail to the Healthcare Facility 104, 108. These healthcare facilities may then access the web-site via the link and provide a user name and password. The Healthcare Facilities 104, 108 may then transfer patient data to or from the Patient File 110 via the Interface 112. In one example, as set forth above, the PACS is enhanced to transfer, store, manipulate, and display healthcare records in non-DICOM formats. In this example, the Call Coordinator 107 may upload non-DICOM data and the Interface 112 stores the non-DICOM data in its native format. In an alternative example, the Interface 112 may encapsulate incoming non-DICOM data in its original form (i.e. in native form) within a DICOM formatted data object or packet. This packet maintains the original data format within the packet and the Interface 112 stores the DICOM object in the Patient File 110. For outgoing retrieved data, the interface 112 de-encapsulates the retrieved data and downloads that data in its native form to the requesting healthcare facility. A Search Engine 119 provides for filters to search the patient file for specific data records (e.g. a specific x-ray).

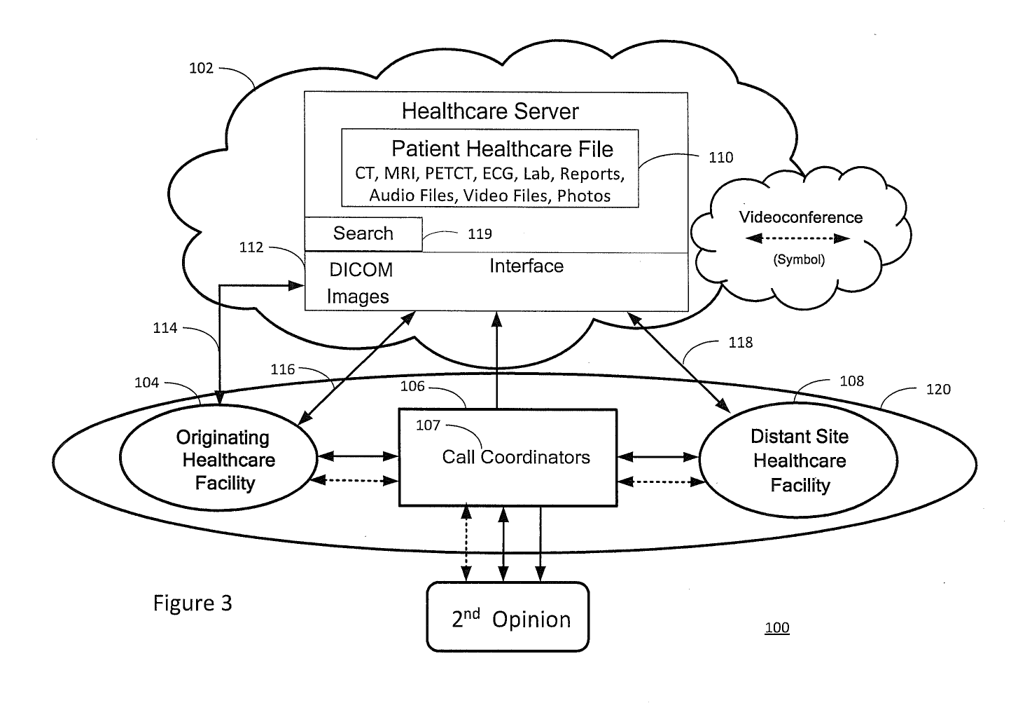

FIG. 3 is a block diagram that illustrates Consolidated Patient Information Exchange 120 in which a Healthcare Server 122 is configured to communicate with a Video Conference Server 124. The Video Conference Server 124 allows personnel from the Originating Healthcare Facility 104 and the Distant Site Healthcare Facility 108, and others such as a second opinion consulting physician, to engage in direct video communications with respect to a given Patient's Healthcare File 110. While the records transfer and the video communications aspects of the integrated electronic health record exchanges may be illustrated in separate figures for purposes of clarity, the video communications and healthcare records transfer and viewing may be accessed from an integrated system with a single user login.

In this regard, a Call Coordinator 107 may simply click on one icon on a screen to automatically launch both the record components and the video conferencing components of the System 120 in a split-screen configuration. A Video Conferencing Component 124 may be launched into a directory screen of the Call Coordinator 107. The Call Coordinator 107 may then send an email link to initiate a call to a specific user, or enter into a “video room” where end-users will automatically connect to and communicate in a multi user environment. An interface page may be launched into an initial screen that allows for patient folder creation or the ability to search for an existing patient healthcare record or patient information sing the Search Engine 119. The size of each of the windows can be manipulated so the end-user is able to view images effectively or have a live video communication with multiple parties. This capability may include being able to have a component in full screen mode and toggling between each component.

In some embodiments, the single Log-in is also available for remote health care providers. For example, remote healthcare providers may receive an html link in a standard email from the Call Coordinator 107. When they click on the link, both components (videoconference and Healthcare Server) can be launched in a web browser. They may then be able to resize the windows, view items in full screen mode and able to toggle between each component. If any party has healthcare information that is not yet uploaded into the Healthcare Server 122, it can be shared via the videoconference using standard data sharing (desktop sharing) protocols.

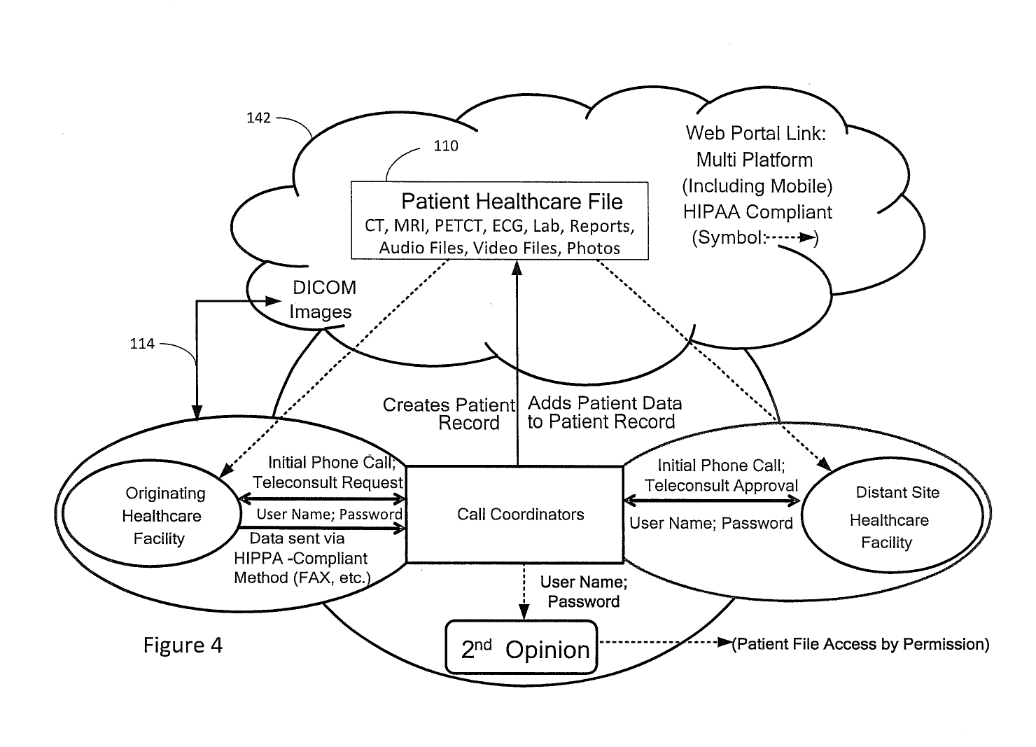

FIG. 4 is a block diagram of illustrating an embodiment of a Consolidated Electronic Patient Information Exchange 140 in which user name and password are required to access information. Transfers of information are preferably encrypted, and preferably comply with HIPAA regulations. FIG. 4 also illustrates a workflow for using the Consolidated Electronic Patient Healthcare Information Exchange 140. In the illustrated embodiment of FIG. 4, the Originating Healthcare Facility 104 may make an initial call to the Call Coordinator 107. The Originating Healthcare Facility 104 then may make a request to the Call Coordinator 107. Records may be provided by the Originating Healthcare Facility 104 to the Call Coordinator 107 by e-mail, fax, or other secure HIPPA compliant means of communication.

The Call Coordinator 107 may also check the Healthcare Server 142 for the existence of a patient record corresponding to the information and/or records from the Originating Healthcare Facility 104. If a Patient File 110 exists, the Call Coordinator 107 may load the transferred records into the Patient File 110 on the Healthcare Server 142. If no Patient File 110 exists, the Call Coordinator 107 creates a Patient File 110 in the Healthcare Server 142 before uploading transferred records into the Healthcare Server 142.

The Call Coordinator 107 may also make an initial phone call to the Distant Site Healthcare Facility 108. Alternatively, the Distant Site Healthcare Facility 108 may initiate contact. The Distant Site Healthcare Facility 108 may then transfer approval to the Distant Site Healthcare Facility 108, upon receiving credentials to access the Patients records, the Call Coordinator 107 may transfer records to the Distant Site Healthcare Facility 108, or the Distant Site Healthcare Facility 108 may access the records directly on the Healthcare Server 142.

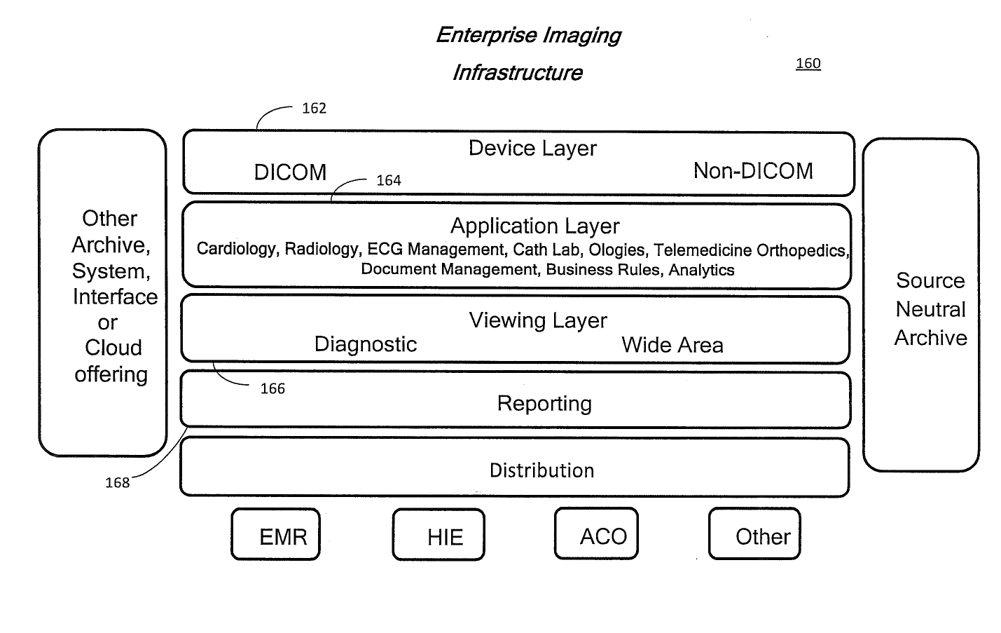

FIG. 5 illustrates an example enterprise image infrastructure for the integrated electronic health record exchange of FIG. 4 in a Layer Diagram 160. A Device Layer 162 concerns communications with DICOM and non-DICOM protocol image devices. An Application Layer 164 concerns applications for data and document handling, and analysis. A Viewing Layer 166 concerns the display of information including diagnostics and a Reporting Layer 168 concerns generation of reports.

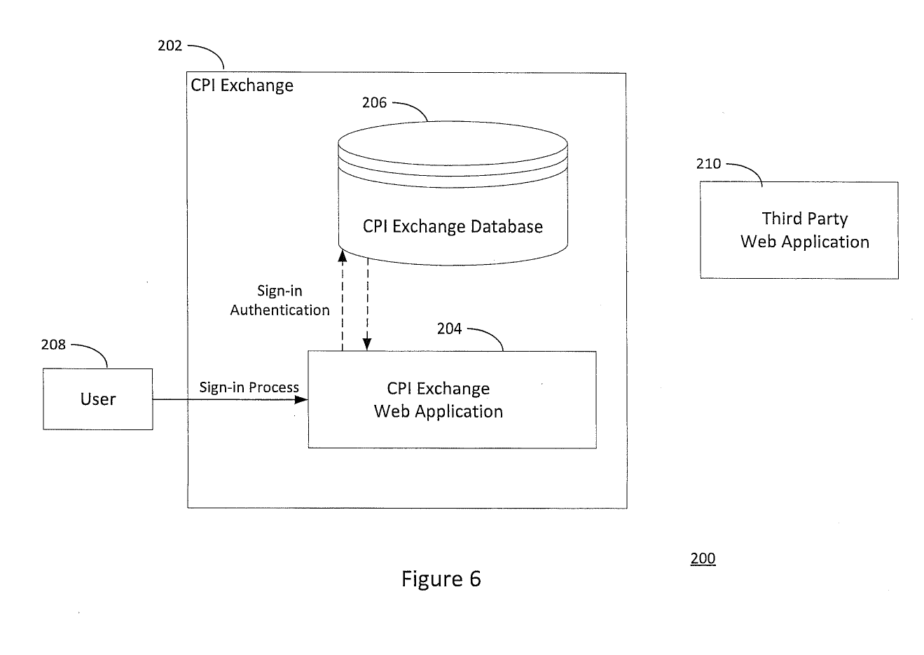

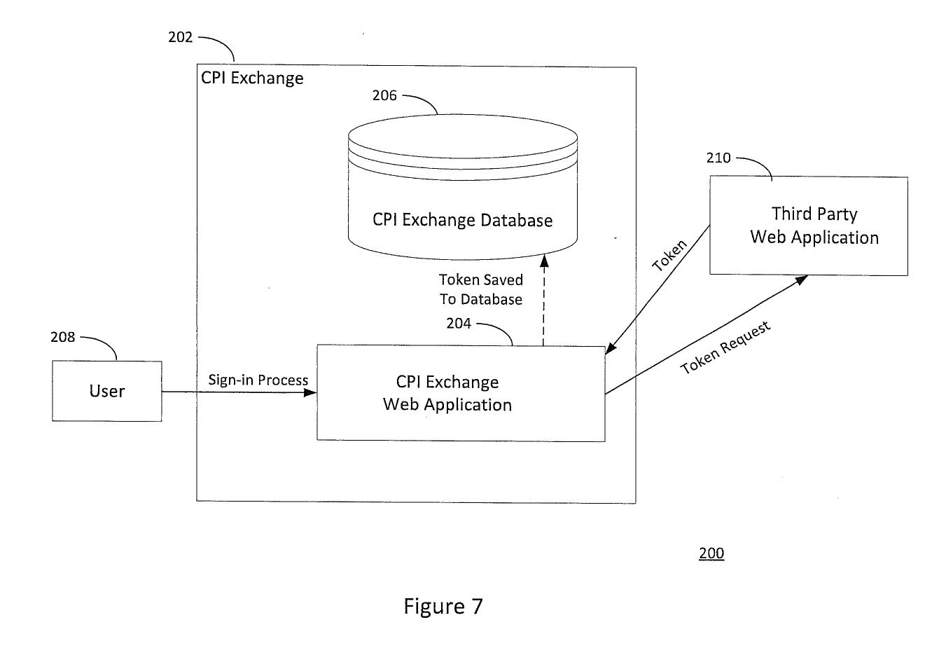

FIGS. 6 and 7 illustrate one example of a computer environment 200 in which the various aspects of the invention may be implemented. In this example, a CPI Exchange 202 may comprise a CPI Exchange Web Application 204 and a CPI Exchange Database 206. A User 208 may access the CPI Exchange Web Application 204 via the Internet or other suitable communications channel. Third Party Web Applications 210, such as Picture Archiving and Communication System (PACS) and video conferencing (VC) accounts, may also be present.

In operation, the User 208 signs in and authenticates to the CPI Exchange Web Application 204, typically with a username and password. Other forms of authentication are contemplated. Once successfully authenticated, the User 208 may be presented with the options to connect their CPI Exchange account with their Third Party Web Applications 210. The User 208 may click a “connect” button to integrate the CPI Exchange Web Application 204 with one of the Third Party Web Applications 210. The User 208 would then be presented input fields to enter their credentials for the selected Third Party Application.

Referring to FIG. 7, The Third Party Web Application 210 validates the credentials of the User 208. If valid, the Third Party Web Application 210 provides an authentication token in return. The CPI Exchange Web Application 204 stores this token in the CPI Exchange Database 206 and associates with the user. The User may add additional third party applications by repeating this process. For future login sessions, the Application validates the user's stored tokens with the 3rd Party Applications. If valid, the Application will display the 3rd Party Application's content and offer its functionality to the user.

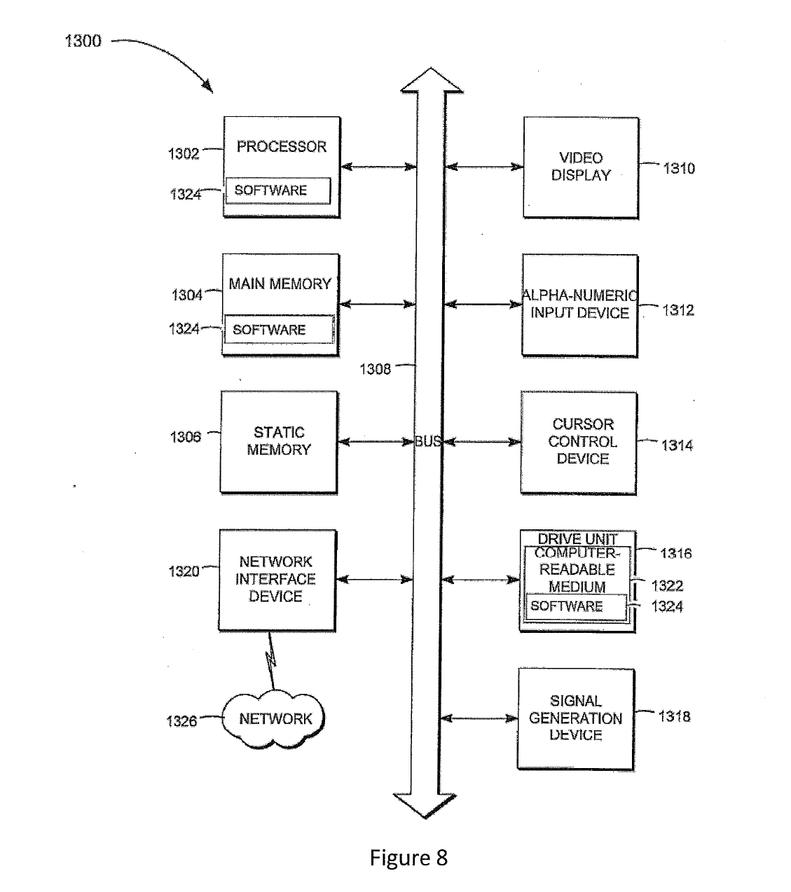

FIG. 8 shows a block diagram of another computer environment in the form of a Computer System 1300 within which a set of instructions may be executed causing the machine to perform any one or more of the methods, processes, operations, or methodologies discussed herein. The Healthcare Server 142, Originating Healthcare

Facility 104, Call Coordination Center 106 and Remote Healthcare Facility 108 may include the structure and functionality of the one or more Computer Systems 1300.

In an example embodiment, the machine operates as a standalone device or may be connected (e.g., networked) to other machines. In a networked deployment, the machine may operate in the capacity of a server (e.g., the healthcare server) or a client machine in server-client network environment, or as a peer machine in a peer-to-peer (or distributed) network environment. The machine may be a, for example, server computer, a client computer, a personal computer (PC), a tablet PC, a Personal Digital Assistant (PDA), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example Computer System 1300 may include a Processor 1302 (e.g., a central processing unit (CPU), a graphics processing unit (GPU) or both), a Main Memory 1304 and a Static Memory 1306, which communicate with each other via a Bus 1308. The Computer System 1300 further includes a Video Display Unit 1310 (e.g., a liquid crystal display (LCD) plasma, or a cathode ray tube (CRT)). The Computer System 1300 also includes an Alphanumeric Input Device 1312 (e.g., a keyboard), a Cursor Control Device 1314 (e.g., a mouse), a Drive Unit 1316, a Signal Generation Device 1318 (e.g., a speaker) and a Network Interface Device 1320.

The Drive Unit 1316 includes a Computer-Readable Medium 1322 on which is stored one or more sets of instructions (e.g., Software 1324) embodying any one or more of the methodologies or functions described herein. The Software 1324 may also reside, completely or at least partially, within the Main Memory 1304 and/or within the Processor 1302 during execution thereof by the Computer System 1300, the Main Memory 1304 and the Processor 1302 also constituting computer-readable media. The Software 1324 may further be transmitted or received over a Network 1326 via the Network Interface Device 1320.

While the Computer-Readable Medium 1322 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, transitory and non-transitory media. Examples of non-transitory media include but are not limited to solid-state memories, optical media, and magnetic media. In some embodiments, the computer-readable medium is a non-transitory computer-readable medium.

The term “based on” or using, as used herein, reflects an open-ended term that can reflect others elements beyond those explicitly recited.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled.

The inventive subject matter may be represented in a variety of different embodiments of which there are many possible permutations.

The systems described herein benefit from the elimination of repetitive data, provide simple, one click capabilities to transfer images from Medical imaging equipment to the Healthcare Server, and provide an organized electronic repository of a Patient's health records, which is accessible by a variety of healthcare providers, even if that provider does not use the same equipment and/or data formats as the transferring provider.

Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. An integrated electronic healthcare exchange system comprising:
a healthcare server including a processor and a memory coupled to the processor, the processor coupled to a communications network;
a processing module in the healthcare server executed by the processor for receiving from a call coordination center, via the communication network, healthcare data including DICOM formatted data and non-DICOM data received from an originating healthcare facility regarding a patient, and which permits a call coordinator to create a patient file, assign a unique claim ID to the patient file, and store the patient file in the memory of the healthcare server;
an interface coupled to the healthcare server and the communication network that encapsulates the received healthcare data into a DICOM formatted packet and stores in the DICOM formatted packet in the patient file; and
a module within the healthcare server which provides access to the stored patient file by the originating healthcare facility through the interface.

2. The system of claim 1 further comprising a video conferencing server coupled to the healthcare server to provide video communications between a distant site healthcare facility and the originating healthcare facility.

3. The system of claim 1 wherein communications between the healthcare server and the call coordinator may be initiated by a single-click.

4. The system of claim 2 wherein the distant site healthcare facility communicates with the healthcare server via the interface which encapsulates non-DICOM data, sent from the distant site healthcare facility, into DICOM formatted packets.

5. The system of claim 2 wherein the originating healthcare facility communicates with the healthcare server via the call coordinator and interface and the interface stores non-DICOM data sent from the originating healthcare facility in its native format.

6. The system of claim 2 wherein the interface provides video conferencing between multiple healthcare facilities including the originating healthcare facility and the distant site healthcare facility while simultaneously providing access to the patient file.

7. The system of claim 2 wherein all communications are encrypted.

8. The system of claim 2 wherein the call coordination center can display patient records and a video conference simultaneously.

9. The system of claim 1 wherein the healthcare server further comprises a search module which permits the coordination center and healthcare facilities to search for specific healthcare data in the patient file and transmit the data in native format.

10. The system of claim 1 wherein the interface de-encapsulates the encapsulated DICOM formatted packets to provide the received healthcare data in native format.

11. A method for consolidated healthcare data exchange comprising:
receiving, at a healthcare server including a server memory via a communication network, healthcare data regarding a patient transmitted from an originating healthcare facility and including DICOM formatted records;
the healthcare server creating a patient file for the patient using the received healthcare data and storing the patient file in the server memory in response to a request for a call coordination center;
receiving, at the healthcare server, non-DICOM formatted healthcare data regarding the patient transmitted from the originating healthcare facility via a call coordinator;
the healthcare server providing access to the stored patient file by a distant site healthcare facility.

12. The method of claim 11 further comprising video conferencing through a video conferencing server exchanging video communication between the distant site healthcare facility and the originating healthcare facility.

13. The method of claim 11 wherein communication between the healthcare server and the call coordination center may be initiated by a single-click.

14. The method of claim 12 wherein the interface provides video conferencing between multiple healthcare facilities including the originating healthcare facility and the distant site healthcare facility while simultaneously providing access to the patient file.

15. The method of claim 12 wherein all communications are encrypted.

16. The method of claim 12 wherein the call coordination center can display patient records and a video conference simultaneously.

17. The method of claim 11 wherein the healthcare server further comprises a search module which permits the coordination center and healthcare facilities to search for specific healthcare data in the patient file and transmit the data in native format.

18. The method of claim 11 wherein an interface encapsulates the non-DICOM formatted healthcare data into DICOM packets prior to storing the healthcare data.
